(19) United States
(12) Patent Application Publication
(10) Pub. No.: US 2026/0359680 A1
(43) Pub. Date: Nov. 12, 2026

(54) METHOD AND APPARATUS OF AUTOMATICALLY RECONSTRUCTING ARTIFICIAL INTELLIGENCE MODEL EVALUATION DATASET

(71) Applicant: ELECTRONICS AND TELECOMMUNICATIONS RESEARCH INSTITUTE, Daejeon (KR)

(72) Inventors: Jeong-Woo Lee, Daejeon (KR); JU WAN KIM, Daejeon (KR); Kyoung-Wook Min, Daejeon (KR); Jeong Dan Choi, Daejeon (KR)

(21) Appl. No.: 19/719,749

(22) Filed: Jun. 25, 2026

(30) Foreign Application Priority Data
Oct. 20, 2024 (KR) 10-2025-0151433

(51) Int. Cl. G06N 5/04

(52) U.S. Cl. CPC G06N 5/04

(57) ABSTRACT

A method of automatically reconstructing an evaluation dataset is performed by a computing device. The method includes performing inference on each training dataset by using each artificial intelligence (AI) model performing a same task to calculate first inference data for each model-dataset combination, comparing the first inference data, generated for each model-dataset combination, with ground truth data included in each training dataset to calculate first performance metrics, analyzing the first performance metrics to select first candidate datasets satisfying a selection condition from among the training datasets, and combining the first candidate datasets to generate a first evaluation dataset.

### CROSS-REFERENCE TO RELATED APPLICATION(S)

This application is based on and claims priority under 35 U.S.C. § 119 to Korean Patent Application No. 10-2025-0151433, filed on Oct. 20, 2025, in the Ministry of Intellectual Property, Republic of Korea, the disclosure of which is incorporated by reference herein in its entirety.

### BACKGROUND

### 1. Field of the Invention

The present disclosure relates to artificial intelligence (AI) technology, and more particularly, to a method and apparatus of automatically reconstructing an AI model evaluation dataset by using performance metrics of a plurality of baseline models.

### 2. Description of Related Art

As machine learning and artificial intelligence (AI) technologies advance, highly advanced models have been continuously being proposed in various application fields. Particularly, in the fields of autonomous driving, medical imaging, and speech recognition requiring safety and reliability, the significance of evaluation datasets for fairly and systematically verifying model performance is more and more increasing.

In the related art, the method that prepares a fixed evaluation dataset separately from an assigned training dataset and compares performances of candidate models has been being used. For example, in the field of autonomous driving, datasets such as KITTI, nuScenes, and the Waymo Open Dataset have been being widely used, and in the field of image recognition, ImageNet, COCO, and CIFAR have been used as standard benchmarks.

Such a fixed evaluation dataset has enabled performance comparison between models but has the following problems. The specific dataset has been biased to a certain environment (for example, daytime, clear weather, etc.) and has not sufficiently reflected complicated scenes such as nighttime, rainy conditions, or intersections.

Consequently, a distribution mismatch between the real service environment and the dataset has occurred, and due to this, a model may have performance below expectation in real-world situations. Also, a number of variant models have been introduced on the same task recently, and each model has different performance patterns on the same dataset. However, the conventional fixed evaluation dataset may not sufficiently reveal the performance deviation between models or may be excessively favorable or unfavorable to specific models.

Thus, in the related art, because the evaluation dataset is static and limited, there have been limitations such as that various performance characteristics of models had not been reflected, and it has been difficult to flexibly respond to a change in distribution or the appearance of a new model.

### SUMMARY

An aspect of the present disclosure is directed to providing a method, which may automatically select a common low-performance dataset and a dataset having a large performance deviation between models by using performance metrics of a plurality of baseline models, may automatically combine the selected datasets to reconstruct an evaluation dataset, and when an update of a baseline model or a dataset occurs, may automatically reconstruct the evaluation dataset through a partial update, and an apparatus for performing the method.

A method, performed by a computing device, of automatically reconstructing an evaluation dataset, according to embodiments of the present disclosure, may include performing inference on each training dataset by using each artificial intelligence (AI) model performing a same task to calculate first inference data for each model-dataset combination, comparing the first inference data, generated for each model-dataset combination, with ground truth data included in each training dataset to calculate first performance metrics, analyzing the first performance metrics to select first candidate datasets satisfying a selection condition from among the training datasets, and combining the first candidate datasets to generate a first evaluation dataset.

The selection condition may include a first selection condition for selecting a dataset of lowest performance metrics in all of the AI models and a second selection condition for selecting a dataset of a greatest performance metrics deviation between the AI models.

The generating of the first evaluation dataset may include determining whether the first candidate datasets satisfy a constraint condition and combining the first candidate datasets satisfying the constraint condition to generate the first evaluation dataset.

A computing device according to embodiments of the present disclosure includes a first processor configured to perform inference on each training dataset by using each artificial intelligence (AI) model performing a same task to calculate first inference data for each model-dataset combination and a second processor, wherein the second processor compares the first inference data, generated for each model-dataset combination, with ground truth data included in each training dataset to calculate first performance metrics, analyzes the first performance metrics, selects first candidate datasets satisfying a selection condition from among the training datasets, based on an analysis result, and combines the first candidate datasets to generate a first evaluation dataset.

A system of automatically reconstructing an evaluation dataset according to embodiments of the present disclosure includes a storage configured to store artificial intelligence (AI) model performing a same task and training datasets and a computing device, wherein the computing device includes a first processor configured to perform inference on each training dataset by using each AI model to calculate first inference data for each model-dataset combination and a second processor, wherein the second processor compares the first inference data, generated for each model-dataset combination, with ground truth data included in each training dataset to calculate first performance metrics, analyzes the first performance metrics, selects first candidate datasets satisfying a selection condition from among the training datasets, based on an analysis result, and combines the first candidate datasets to generate a first evaluation dataset.

The second processor may determine whether the first candidate datasets satisfy a constraint condition and combine the first candidate datasets satisfying the constraint condition to generate the first evaluation dataset.

A method and apparatus of automatically reconstructing an AI model evaluation dataset may automatically select a common low-performance dataset and a dataset having a large performance deviation between models by using performance metrics of a plurality of baseline models, may automatically combine the selected datasets to reconstruct an evaluation dataset, and when an update of a baseline model or a dataset occurs, may automatically reconstruct the evaluation dataset through a partial update.

It is to be understood that both the foregoing general description and the following detailed description of the present invention are exemplary and explanatory and are intended to provide further explanation of the invention as claimed.

### BRIEF DESCRIPTION OF THE DRAWINGS

Detailed descriptions of each drawing are provided to facilitate the sufficient understanding of the drawings cited in the detailed description of the present disclosure.

FIG. 1 is a block diagram of an evaluation dataset reconstruction system including a computing device which automatically reconstructs an autonomous driving artificial intelligence (AI) model evaluation dataset according to an embodiment of the present disclosure.

FIG. 2 is a flowchart for describing an operation of the evaluation dataset reconstruction system illustrated in FIG. 1.

FIG. 3 is a conceptual diagram for describing an operation of an inference module executed in a computing device illustrated in FIG. 1.

FIG. 4 is a diagram illustrating an embodiment of a first performance metrics matrix generated by a performance metrics calculation module executed in the computing device illustrated in FIG. 1.

FIG. 5 is a diagram illustrating an embodiment of a constraint condition on an evaluation dataset generation module executed in the computing device illustrated in FIG. 1.

FIG. 6 is a conceptual diagram illustrating an operation of the inference module executed in the computing device illustrated in FIG. 1 when a training dataset is updated.

FIG. 7 is a diagram illustrating an embodiment of a second performance metrics matrix generated by the performance metrics calculation module executed in the computing device illustrated in FIG. 1 when the training dataset is updated.

FIG. 8 is a conceptual diagram for describing an operation of the inference module executed in the computing device illustrated in FIG. 1 when an AI model is updated.

FIG. 9 is a diagram illustrating an embodiment of a second performance metrics matrix generated by the performance metrics calculation module executed in the computing device illustrated in FIG. 1 when the AI model is updated.

### DETAILED DESCRIPTION OF THE INVENTION

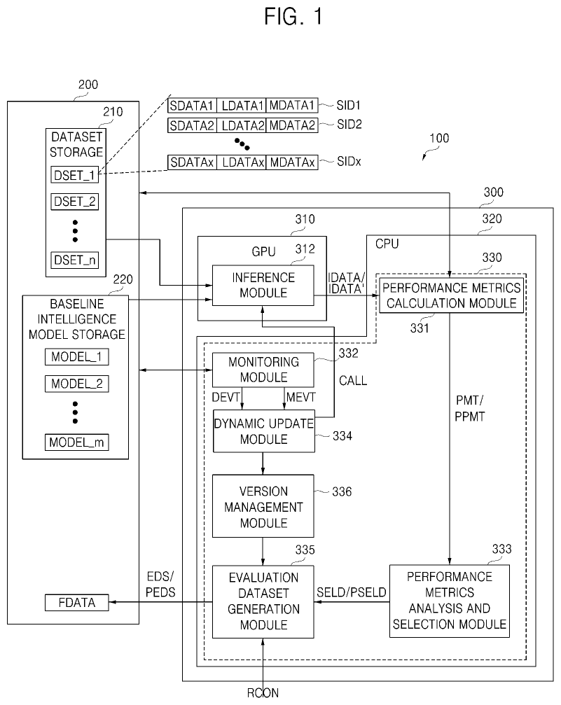

FIG. 1 is a block diagram of an evaluation dataset reconstruction system 100 including a computing device which automatically reconstructs an autonomous driving artificial intelligence (AI) model evaluation dataset according to an embodiment of the present disclosure.

Referring to FIG. 1, the evaluation dataset reconstruction system 100 for performing a method of automatically reconstructing an AI model evaluation dataset may include a storage 200 and a computing device 300.

The storage 200 may include a dataset storage 210 which stores a plurality of (or n number of) training datasets DSET_1 to DSET_n) (where n may be a natural number of 2 or more) and a baseline intelligence model storage 220 which stores a plurality of (or m number of) baseline intelligence models MODEL_1 to MODEL_m (where m may be a natural number of 2 or more). Each of the storages 200, 210, and 220 may be a database or a data storage device accessible by the computing device 300.

Each of the plurality of training datasets DSET_1 to DSET_n may be an autonomous driving training dataset.

Each of the autonomous driving training datasets DSET_1 to DSET_n respectively including labels may be various datasets for training the baseline intelligence models MODEL_1 to MODEL_m, and each of the autonomous driving training datasets DSET_1 to DSET_n may include human-labeled ground truth data.

A baseline intelligence model may denote an intelligence model of the most basic level which is used as a comparison criterion before generating a complicated or sophisticated model, in an AI system, an intelligent model, or a machine learning issue.

The computing device 300 for automatically reconstructing an evaluation dataset may include a first-type processor 310 and a second-type processor 320.

The first-type processor 310 may be a cluster which includes at least one graphics processing unit (GPU) for executing an inference module 312, the second-type processor 320 may be a cluster which includes at least one CPU for executing a program 330, and the program 330 may include a plurality of modules 331 to 336 described herein.

A module described herein may be designed or programmed to perform a certain function through functional coupling or to allow different parts to interact through structural coupling. Such a module may be written in a program code and may process a certain task in a code.

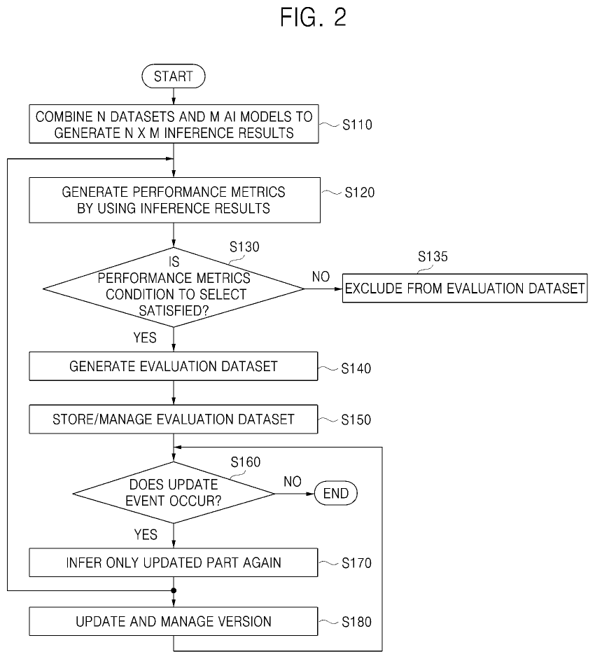

FIG. 2 is a flowchart for describing an operation of the evaluation dataset reconstruction system illustrated in FIG. 1.

Referring to FIGS. 1 and 2, the autonomous driving training datasets DSET_1 to DSET_n and the baseline intelligence models MODEL_1 to MODEL_m may be used as an input of the inference model 312 executed in the first processor 310.

Each of the baseline intelligence models MODEL_1 to MODEL_m may be an AI model which performs the same intelligence task. An intelligence task may denote a unit of AI processing for performing a certain function in an autonomous driving system, and examples of representative intelligence tasks may include, for example, object detection, path prediction, driving planning, control, situation recognition, and abnormal situation detection.

Each of the autonomous driving training datasets DSET_1 to DSET_n may be a dataset for a certain intelligence task.

Herein, each of the baseline intelligence models (for example, first to mth baseline intelligence models) MODEL_1 to MODEL_m may be assumed to be an autonomous driving three-dimensional (3D) object detection intelligence model, and each of the autonomous driving training datasets (for example, first to nth autonomous driving training datasets) DSET_1 to DSET_n may be assumed to be a dataset which is used for autonomous driving 3D object detection training and evaluation.

For convenience of description, it may be assumed that the first baseline intelligence model MODEL_1 is PointPillars, the second baseline intelligence model MODEL_2 is SECOND, the third baseline intelligent model MODEL_3 is CenterPoint, and it may be assumed that the first autonomous driving training dataset DSET_1 is KITTI 3D, the second autonomous driving training dataset DSET_2 is nuScenes, and the third autonomous driving training dataset DSET_3 is Waymo.

Each of the training datasets DSET_1 to DSET_3 may include a plurality of data samples, and each of the plurality of data samples may include sensor data, ground truth data, and metadata.

As illustrated in FIG. 1, the first training dataset DSET_1 may include x number of data samples SID1 to SIDx (where x may be a natural number of 2 or more), and each of the data samples SID1 to SIDx may include pieces of sensor data SDATA1 to SDATAx, pieces of ground truth data LDATA1 to LDATAx, and pieces of metadata MDATA1 to MDATAx.

Each of the metadata MDATA1 to MDATAx may include type, coverage, class statistics, collection time, personal information sensitivity, and hash/signature.

The type may be information which distinguishes a form or character of a data sample and includes a sensor type (for example, an image sensor, a light detection and ranging (LiDAR) sensor, or a radio detection and ranging (RADAR) sensor), a data format (for example, an RGB image or a point cloud), and an annotation format (for example, a 3D bounding box or a segmentation mask).

The coverage may denote information about a range or a condition included in a data sample and may include geographic coverage (for example, Seoul, Busan, or the like), environmental coverage (for example, day/night, a weather condition, etc.), and a road type (for example, highway, urban road, etc.).

The class statistics may be object class-based distribution information included in a dataset and may include the total number of objects and a class-based proportion.

The collection time may include a time (date and time) at which a corresponding data sample or dataset is collected.

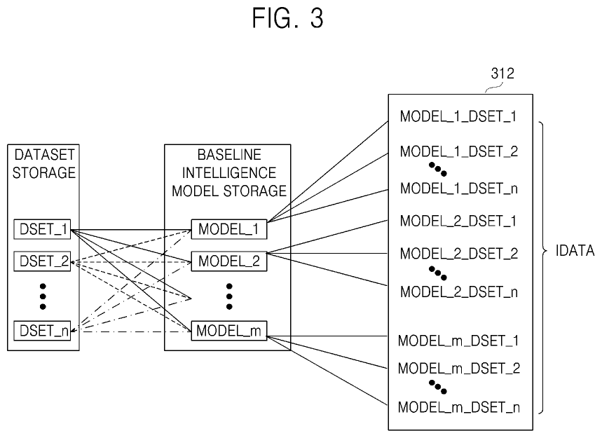

FIG. 3 is a conceptual diagram for describing an operation of the inference module 312 executed in the computing device 300 illustrated in FIG. 1.

Referring to FIGS. 1 to 3, in step S110, the inference module 312 may perform inference on each combination of three training datasets DSET_1 to DSET_n by using each of three AI models MODEL_1 to MODEL_3 to generate inference results (i.e., first inference data IDATA) for each of nine model-dataset combinations, based on an inference result.

The inference module 312 may generate the first inference data IDATA for each of model-dataset combinations MODEL_1_DSET_1 to MODEL_1_DSET_3, MODEL_2_DSET_1 to MODEL_2_DSET_3, and MODEL_3_DSET_1 to MODEL_3_DSET_3 in step S110.

The first inference data IDATA for each model-dataset combination may include an inference result and an execution log. The inference result may include a prediction label representing a class predicted by an AI model on input data and a prediction confidence level of the AI model on each class, and the execution log may include a time taken in processing each data sample and the number of retries and errors occurring when performing inference.

The performance metrics calculation module 331 may calculate first performance metrics (for example, AP, NDS, and L2 mAPH) by using the first inference data IDATA of each model-dataset combination MODEL_1_DSET_1, MODEL_1_DSET_2, MODEL_1_DSET_3, MODEL_2_DSET_1, MODEL_2_DSET_2, MODEL_2_DSET_3, MODEL_3_DSET_1, MODEL_2_DSET_2, and MODEL_3_DSET_3 and ground truth data of each dataset DSET_1, DSET_2, and DSET_3 and may generate a first performance metrics matrix PMT including the calculated first performance metrics in step S120.

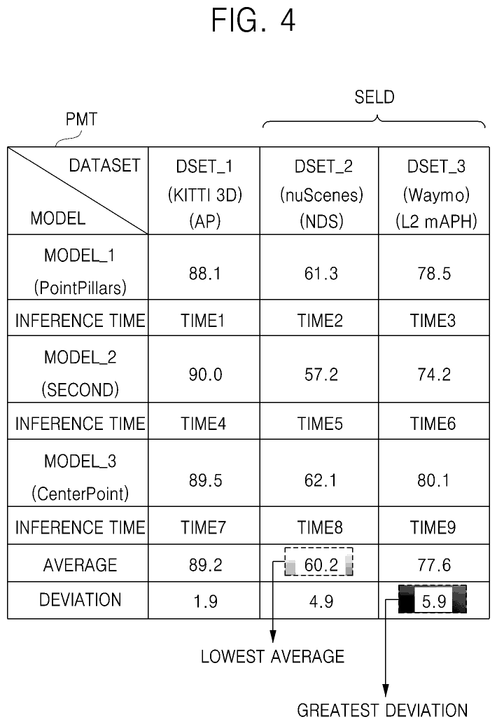

As illustrated in FIG. 4, the first performance metrics matrix PMT may include the first performance metrics for each model-dataset combination and inference times TIME1 to TIME9.

The first performance metrics included in the first performance metrics matrix PMT may be calculated according to standards for each dataset, and for example, first performance metrics of KITTI 3D may be average precision (AP) based on IoU, first performance metrics of nuScenes may be NuScenes detection score (NDS), first performance metrics of Waymo may be mean average precision weighted by heading (L2 mAPH). The first performance metrics matrix PMT may further include at least one of latency or throughput for each model-dataset combination.

The first performance metrics included in the first performance metrics matrix PMT may further include a sample size, a confidence interval, and a class/domain weight.

The sample size may be the number of data samples used for performance evaluation, the confidence interval may represent an uncertainty range of estimated performance metrics and may generally use a 95% confidence interval, and the class/ domain weight may be performance metrics which is calculated by assigning a weight to each class or domain (for example, daytime and nighttime, and urban and highway) so as to correct class imbalance or domain bias.

A performance metrics analysis and selection module 333 for determining whether a performance metrics condition to select is satisfied may receive and analyze the first performance metrics matrix PMT, and based on an analysis result, may select a plurality of first candidate datasets satisfying a pre-set selection condition from among the training datasets DSET_1 to DSET_3 in step S130.

For example, the selection condition may include a first selection condition which selects a dataset of lowest performance metrics from among all AI models MODEL_1 to MODEL_3 and a second selection condition which selects a dataset of a greatest performance metrics deviation between the AI models MODEL_1 to MODEL_3.

As illustrated in FIG. 4, based on the first selection condition, the dataset (referred to as a ‘common low-performance dataset’) of lowest performance metrics (for example, an average of each of AP, NDS, and L2 mAPH) in all AI models MODEL_1 to MODEL_3 may denote a second dataset DSET_2, and based on the second selection condition, the dataset (referred to as a ‘high-deviation dataset’) of greatest performance metrics deviation (for example, each of AP, NDS, and L2 mAPH) between the AI models MODEL_1 to MODEL_3 may denote a third dataset DSET_3.

For example, the performance metrics analysis and selection module 333 may identify, as common low-performance data, a specific data sample (for example, nighttime and rainy images) in the second dataset “DSET_2=nuScenes” and may identify, as high-deviation data, the specific data sample (for example, a complicated intersection image) in the third dataset “DSET_3=Waymo”.

The performance metrics analysis and selection module 333 may select the second dataset DSET_2 and the third dataset DSET_3, satisfying the selection condition, as first candidate datasets SELD from among the datasets DSET_1, DSET_2, and DSET_3 in step S130.

The evaluation dataset generation module 335 may combine the first candidate datasets SELD to generate a first evaluation dataset EDS in step S140. For example, the evaluation dataset generation module 335 may generate the first evaluation dataset EDS by units of one dataset, or may generate the first evaluation dataset EDS by units of one dataset sample.

The evaluation dataset generation module 335 may determine whether first candidate datasets DSET_2 and DSET_3 satisfy a pre-set constraint condition RCON and may combine the first candidate datasets DSET_2 and DSET_3 satisfying the pre-set constraint condition RCON to generate the first evaluation dataset EDS in step S140.

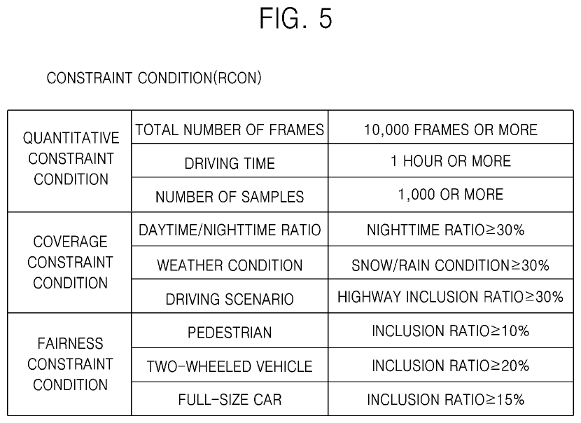

FIG. 5 is a diagram illustrating an embodiment of a constraint condition on the evaluation dataset generation module 335 executed in the computing device 300 illustrated in FIG. 1.

Referring to FIGS. 1 to 5, the constraint condition RCON may include a quantitative constraint condition (or range), a coverage constraint condition, and a fairness constraint condition.

The quantitative constraint condition may include at least one of the total number of frames (for example, 10,000 frames or more), a driving time (for example, 1 hour or more), and the number of data samples (for example, 1,000 or more).

The coverage constraint condition may include at least one of a ratio of daytime to nighttime (for example, a nighttime ratio of 30% or more), a weather condition (for example, at least one of rain or snow is 30% or more), and a driving scenario (for example, a highway inclusion ratio of 30% or more).

The fairness constraint condition may include a minimum inclusion ratio on a specific object. For example, the fairness constraint condition may be configured to include a minimum percentage of a pedestrian scenes while including a certain ratio of night, rainy, and intersection scenes (referred to as a ‘data sample’).

For example, the fairness constraint condition may include at least one of a pedestrian ratio (for example, an inclusion ratio of 10% or more), a two-wheeled vehicle ratio (for example, an inclusion ratio of 20% or more), or a full-size car ratio (for example, an inclusion ratio of 15% or more).

The evaluation dataset generation module 335 may determine whether the first candidate datasets DSET_2 and DSET_3 satisfy the pre-set constraint condition RCON in step S130, and when the pre-set constraint condition RCON is all satisfied (YES in S130), the evaluation dataset generation module 335 may combine the first candidate datasets DSET_2 and DSET_3 to generate the first evaluation dataset ESD in step S140.

However, the evaluation dataset generation module 335 may determine whether the first candidate datasets DSET_2 and DSET_3 satisfy the pre-set constraint condition RCON, and when the pre-set constraint condition RCON is not all satisfied (NO in S130), the evaluation dataset generation module 335 may not select the first candidate datasets DSET_2 and DSET_3 as the first evaluation dataset ESD in step S135.

The evaluation dataset generation module 335 may generate a final dataset FDATA including the first evaluation dataset ESD, version information about the first evaluation dataset ESD, and metadata and may store and manage the final dataset FDATA in the storage 200 in step S150.

When the first evaluation dataset ESD corresponding to first version is generated, the evaluation dataset generation module 335 may generate the metadata including the reason for selecting the first evaluation dataset ESD (for example, common low-performance data in case of nighttime and rain, and high-deviation data at complicated intersections).

The final dataset FDATA may be used to evaluate a new AI model in an autonomous driving simulator or a benchmark engine.

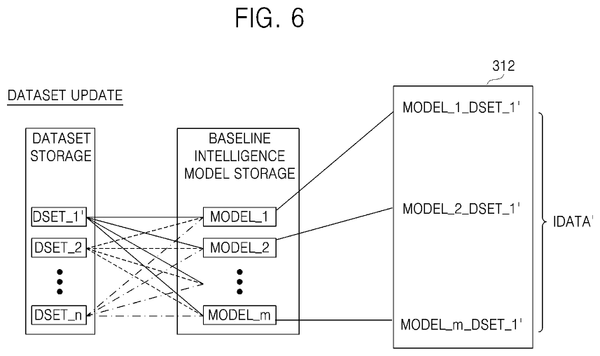

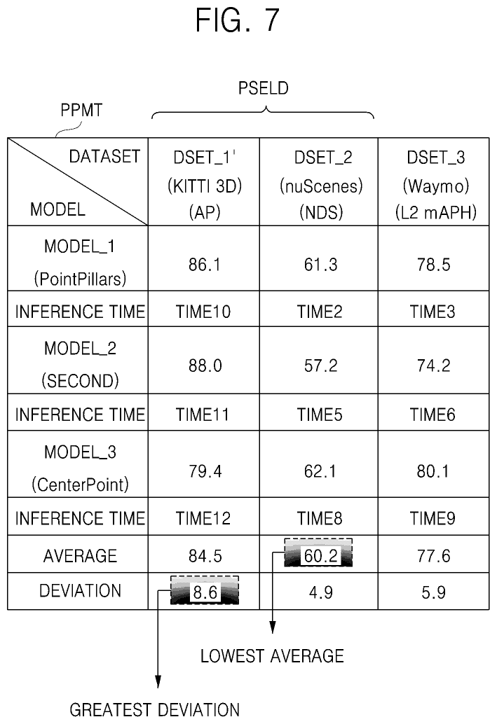

FIG. 6 is a conceptual diagram illustrating an operation of the inference module 312 executed in the computing device 300 illustrated in FIG. 1 when a training dataset is updated, and FIG. 7 is a diagram illustrating an embodiment of a second performance metrics matrix PPMT generated by the performance metrics calculation module 331 executed in the computing device 300 illustrated in FIG. 1 when the training dataset is updated.

The monitoring module 332 may monitor whether the training datasets DSET_1, DSET_2, and DSET_3 stored in the storage 200 have been updated in step S160, and when at least one of the training datasets DSET_1, DSET_2, and DSET_3 has been updated (YES in S160), the monitoring module 332 may generate a first update event DEVT and may output the first update event DEVT to a dynamic update module 334. When the update event DEVT and an update event MEVT do not occur (NO in S160), such step may end in a state where the final dataset FDATA associated with the first evaluation dataset ESD is stored in the storage 200.

An update of a training dataset may include at least one of registration of a new dataset, addition of a new data sample to an existing dataset, modification of a rule for the existing dataset, and changing of a data distribution of the existing dataset.

In response to the first update event DEVT, the dynamic update module 334 may generate a call signal CALL representing whether an arbitrary training dataset has been updated and may transmit the call signal CALL to the inference module 312.

For example, when a new data sample is added to the first dataset “DSET_1=KITTI 3D”, and in response to the first update event DEVT, the dynamic update module 334 may generate the call signal CALL representing that the new data sample has been added to the first dataset “DSET_1=KITTI 3D” and may transmit the call signal CALL to the inference module 312.

Instead of performing inference on all of nine model-dataset combinations again, the inference module 312 may again perform inference on only three model-updated dataset combinations MODEL_1_DSET_1′, MODEL_2_DSET_1′, and MODEL_3_DSET_1′ associated with an updated first dataset DSET_1′, may calculate second inference data IDATA′ for each of the model-updated dataset combinations MODEL_1_DSET_1′, MODEL_2_DSET_1′, and MODEL_3_DSET_1′, and may transmit the second inference data IDATA′ to the performance metrics calculation module 331 in step S170.

According to an embodiment of the present disclosure, in a case where the second inference data IDATA′ is transmitted to the performance metrics calculation module 331, the first performance metrics calculated for each of non-updated model-dataset combinations MODEL_1_DSET_2, MODEL_1_DSET_3, Model_2_dset_2, Model_2_dset_3, Model_3_dset_2, and MODEL_3_DSET_3 may also be transmitted to the performance metrics calculation module 331 together.

According to another embodiment, the performance metrics calculation module 331 may store the first performance metrics matrix PMT.

The performance metrics calculation module 331 may compare the second inference data IDATA′, calculated for each of the model-updated dataset combinations MODEL_1_DSET_1′, MODEL_2_DSET_1′, and MODEL_3_DSET_1′, with ground truth data included in the updated second dataset DSET_1′ and may recalculate second performance metrics for each of the model-updated dataset combinations MODEL_1_DSET_1′, MODEL_2_DSET_1′, and MODEL_3_DSET_1′.

The performance metrics calculation module 331 may generate the second performance metrics matrix PPMT which includes the first performance metrics calculated for each of the model-dataset combinations MODEL_1_DSET_2, MODEL_1_DSET_3, MODEL_2_DSET_2, MODEL_2_DSET_3, MODEL_3_DSET_2, and MODEL_3_DSET_3 and the second performance metrics calculated for each of the model-updated dataset combinations MODEL_1_DSET_1′, MODEL_2_DSET_1′, and MODEL_3_DSET_1′ and may transmit the second performance metrics matrix PPMT to the performance metrics analysis and selection module 333.

As illustrated in FIG. 7, the second performance metrics matrix PPMT may include inference times TIME10, TIME11, and TIME12 of the model-updated dataset combinations MODEL_1_DSET_1′, MODEL_2_DSET_1′, and MODEL_3_DSET_1′.

The performance metrics analysis and selection module 333 may analyze the second performance metrics matrix PPMT, may identify the updated first dataset DSET_1′ as a high-deviation dataset, based on a analysis result, may identify the second dataset DSET_2 as a common low-performance dataset, and may select the updated first dataset DSET_1′ and the second dataset DSET_2 as second candidate datasets PSELD.

The evaluation dataset generation module 335 may combine the second candidate datasets PSELD to generate a second evaluation dataset PEDS in step S140.

The evaluation dataset generation module 335 may determine whether the second candidate datasets DSET_1′ and DSET_2 satisfy the pre-set constraint condition RCON and may combine the second candidate datasets DSET_1′ and DSET_2 satisfying the pre-set constraint condition RCON to generate the second evaluation dataset PESD in step S140.

A version management module 336 may assign a version number to the second evaluation dataset PESD and may compare the first evaluation dataset ESD with the second evaluation dataset PESD to record a difference between a modified part and performance metrics in step S180.

Referring to FIGS. 4 and 7, performance metrics AP of MODEL_1_DSET_1 has decreased by −2 from 88.1 to 86.1, performance metrics AP of MODEL_2_DSET_1 has decreased by −2 from 90.0 to 88.0, and performance metrics AP of MODEL_3_DSET_1 has decreased by −10.1 from 89.5 to 79.4.

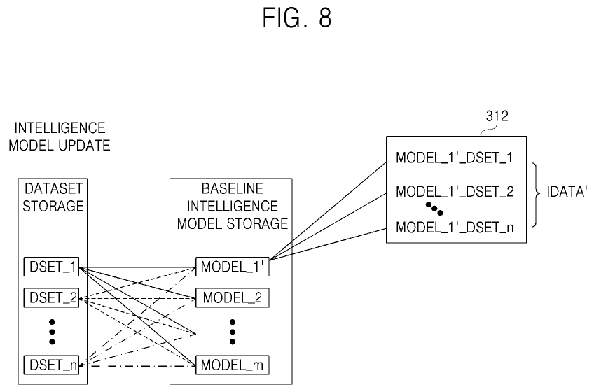

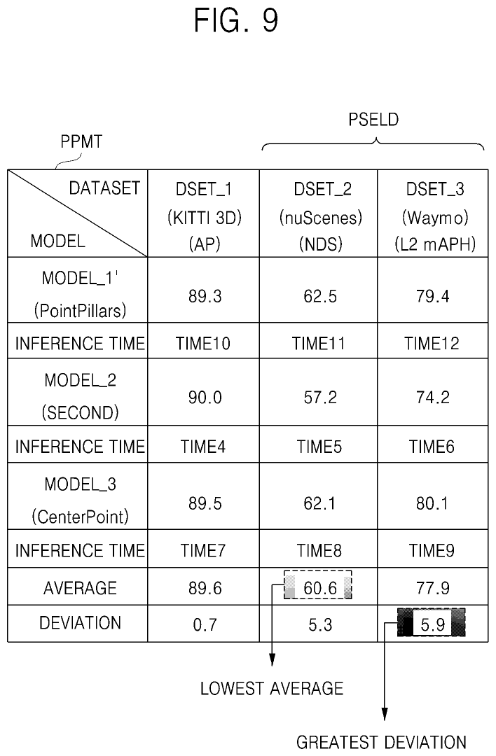

FIG. 8 is a conceptual diagram for describing an operation of the inference module 312 executed in the computing device 300 illustrated in FIG. 1 when an AI model is updated, and FIG. 9 is a diagram illustrating an embodiment of a second performance metrics matrix generated by the performance metrics calculation module 331 executed in the computing device 300 illustrated in FIG. 1 when the AI model is updated.

The monitoring module 332 may monitor whether at least one of the AI models MODEL_1, MODEL_2, and MODEL_3 stored in the storage 200 has been updated in step S160, and when one of the AI models MODEL_1, MODEL_2, and MODEL_3 has been updated (YES in S160), the monitoring module 332 may generate the second update event MEVT and may output the second update event MEVT to the dynamic update module 334.

The update of the AI model may include at least one of registration of a new AI model and a version update of an existing AI model.

In response to the second update event MEVT, the dynamic update module 334 may generate the call signal CALL representing whether an arbitrary training dataset has been updated and may transmit the call signal CALL to the inference module 312.

For example, when a version of the first AI model MODEL_1′ has been updated, the dynamic update module 334 may generate the call signal CALL which calls only the updated first AI model MODEL_1′ and may transmit the call signal CALL to the inference module 312, in response to the second update event MEVT.

Instead of performing inference on all of nine model-dataset combinations again, the inference module 312 may again perform inference on only three updated model-dataset combinations MODEL_1′_DSET_1, MODEL_1′_DSET_2, and MODEL_1′_DSET_3 associated with the updated first AI model MODEL_1′, may calculate the second inference data IDATA′ for each of the updated model-dataset combinations MODEL_1′_DSET_1, MODEL_1′_DSET_2, and MODEL_1′_DSET_3, and may transmit the second inference data IDATA′ to the performance metrics calculation module 331 in step S170.

According to an embodiment of the present disclosure, in a case where the second inference data IDATA′ is transmitted to the performance metrics calculation module 331, the first performance metrics calculated for each of non-updated model-dataset combinations MODEL_2_DSET_1, MODEL_2_DSET_2, MODEL_2_DSET_3, MODEL_3_DSET_1, MODEL_3_DSET_2, and MODEL_3_DSET_3 may also be transmitted to the performance metrics calculation module 331.

The performance metrics calculation module 331 may compare the second inference data IDATA′, calculated for each of the updated model-dataset combinations MODEL_1′_DSET_1, MODEL_1′_DSET_2, and MODEL_1′_DSET_3, with ground truth data included in each of the datasets DSET_1, DSET_2, and DSET_3 to calculate second performance metrics for each of the updated model-dataset combinations MODEL_1′_DSET_1, MODEL_1′_DSET_2, and MODEL_1′_DSET_3.

The performance metrics calculation module 331 may generate the second performance metrics matrix PPMT which includes the first performance metrics calculated for each of the model-dataset combinations MODEL_2_DSET_1, MODEL_2_DSET_2, MODEL_2_DSET_3, MODEL_3_DSET_1, MODEL_3_DSET_2, and MODEL_3_DSET_3 and the second performance metrics calculated for each of the updated model-dataset combinations MODEL_1′_DSET_1, MODEL_1′_DSET_2, and MODEL_1′_DSET_3 and may transmit the second performance metrics matrix PPMT to the performance metrics analysis and selection module 333.

As illustrated in FIG. 9, the second performance metrics matrix PPMT may include inference times TIME10, TIME11, and TIME12 of the updated model-dataset combinations MODEL_1′_DSET_1, MODEL_1′_DSET_2, and MODEL_1′_DSET_3.

According to an embodiment, the performance metrics calculation module 331 may update the first performance metrics matrix PMT to the second performance metrics matrix PPMT and transmit the second performance metrics matrix PPMT to the performance metrics analysis and selection module 333.

The performance metrics analysis and selection module 333 may analyze the second performance metrics matrix PPMT, may identify the second dataset DSET_2 as a common low-performance dataset, may identify the third dataset DSET_3 as a high-deviation dataset, and may select the second dataset DSET_2 and the third dataset DSET_3 as the second candidate datasets PSELD.

The evaluation dataset generation module 335 may combine the second candidate datasets PSELD to generate the second evaluation dataset PEDS in step S140.

The evaluation dataset generation module 335 may determine whether the second candidate datasets DSET_2 and DSET_3 satisfy the pre-set constraint condition RCON and may combine the second candidate datasets DSET_2 and DSET_3 satisfying the pre-set constraint condition RCON to generate the second evaluation dataset PESD in step S140.

The version management module 336 may assign a version number to the second evaluation dataset PESD and may compare the first evaluation dataset ESD with the second evaluation dataset PESD to record a difference between a modified part and performance metrics in step S180.

Referring to FIGS. 4 and 9, performance metrics AP of MODEL_1′_DSET_1 has increased by 1.2 from 88.1 to 89.3, performance metrics NDS of MODEL_1_DSET_1 has increased by 1.2 from 61.3 to 62.5, and performance metrics L2 mAPH of MODEL_1′ _DSET_3 has increased by 0.9 from 78.5 to 79.4.

As described above, the method and apparatus of automatically reconstructing an AI model evaluation dataset according to embodiments of the present disclosure may automatically select a common low-performance dataset and a dataset having a large performance deviation between models by using performance metrics of a plurality of baseline models, may automatically combine the selected datasets to reconstruct an evaluation dataset, and when an update of a baseline model or a dataset occurs, may automatically reconstruct the evaluation dataset through a partial update, and an apparatus for performing the method.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method, performed by a computing device, of automatically reconstructing an evaluation dataset, the method comprising:
performing inference on each training dataset by using each artificial intelligence (AI) model performing a same task to calculate first inference data for each model-dataset combination;
comparing the first inference data, generated for each model-dataset combination, with ground truth data included in each training dataset to calculate first performance metrics;
analyzing the first performance metrics to select first candidate datasets satisfying a selection condition from among the training datasets; and
combining the first candidate datasets to generate a first evaluation dataset.

2. The method of claim 1, wherein the selection condition comprises:
a first selection condition for selecting a dataset of lowest performance metrics from among the first performance metrics for each model-dataset combination in all of the AI models; and
a second selection condition for selecting a dataset of a greatest performance metrics deviation between the AI models from among the first performance metrics for each model-dataset combination.

3. The method of claim 1, wherein the generating of the first evaluation dataset comprises:
determining whether the first candidate datasets satisfy a constraint condition; and
combining the first candidate datasets satisfying the constraint condition to generate the first evaluation dataset.

4. The method of claim 3, wherein the constraint condition comprises at least one of:
a quantitative constraint condition related to at least one of the total number of frames, a driving time, and the number of samples;
a coverage constraint condition related to at least one of a ratio of daytime to nighttime, a weather condition, and a driving scenario; and
a fairness constraint condition related to a minimum inclusion ratio on a specific object.

5. The method of claim 1, further comprising:
generating an update event representing that one of the AI models is updated; and
re-performing inference on each training dataset by using only an updated AI model, based on the update event, and calculating second inference data for each updated model-dataset combination, based on a result of the re-performed inference.

6. The method of claim 5, further comprising:
comparing the second inference data, calculated for each updated model-dataset combination, with the ground truth data included in each training dataset to calculate second performance metrics;
analyzing the second performance metrics calculated for each updated model-dataset combination and the first performance metrics calculated for each non-updated model-dataset combination to select second candidate datasets satisfying the selection condition from among the training datasets; and
combining the second candidate datasets to generate a second evaluation dataset.

7. The method of claim 6, wherein the selection condition comprises:
a first selection condition for selecting a dataset of lowest performance metrics in all of the AI models; and
a second selection condition for selecting a dataset of a greatest performance metrics deviation between the AI models.

8. The method of claim 6, wherein the generating of the second evaluation dataset comprises:
determining whether the second candidate datasets satisfy a constraint condition; and
combining the second candidate datasets satisfying the constraint condition to generate the second evaluation dataset.

9. The method of claim 1, further comprising:
generating an update event representing that one of the training datasets is updated; and
re-performing inference on only an updated training dataset by using each of the AI models, based on the update event, and calculating second inference data for each model-updated dataset combination, based on a result of the re-performed inference.

10. The method of claim 9, further comprising:
comparing the second inference data, calculated for each model-updated dataset combination, with the ground truth data included in each training dataset to calculate second performance metrics;
analyzing the second performance metrics calculated for each model-updated dataset combination and the first performance metrics calculated for each non-updated model-dataset combination to select second candidate datasets satisfying the selection condition from among the training datasets; and
combining the second candidate datasets to generate a second evaluation dataset.

11. The method of claim 10, wherein the selection condition comprises:
a first selection condition for selecting a dataset of lowest performance metrics in all of the AI models; and
a second selection condition for selecting a dataset of a greatest performance metrics deviation between the AI models.

12. The method of claim 10, wherein the generating of the second evaluation dataset comprises:
determining whether the second candidate datasets satisfy a constraint condition; and
combining the second candidate datasets satisfying the constraint condition to generate the second evaluation dataset.

13. A computing device comprising:
a first processor configured to perform inference on each training dataset by using each artificial intelligence (AI) model performing a same task to calculate first inference data for each model-dataset combination; and
a second processor,
wherein the second processor
compares the first inference data, generated for each model-dataset combination, with ground truth data included in each training dataset to calculate first performance metrics,
analyzes the first performance metrics,
selects first candidate datasets satisfying a selection condition from among the training datasets, based on an analysis result, and
combines the first candidate datasets to generate a first evaluation dataset.

14. The computing device of claim 13, wherein the selection condition comprises:
a first selection condition for selecting a dataset of lowest performance metrics in all of the AI models; and
a second selection condition for selecting a dataset of a greatest performance metrics deviation between the AI models.

15. The computing device of claim 13, wherein the second processor
determines whether the first candidate datasets satisfy a constraint condition, and
combines the first candidate datasets satisfying the constraint condition to generate the first evaluation dataset.

16. The computing device of claim 15, wherein the constraint condition comprises at least one of:
a quantitative constraint condition related to at least one of the total number of frames, a driving time, and the number of samples;
a coverage constraint condition related to at least one of a ratio of daytime to nighttime, a weather condition, and a driving scenario; and
a fairness constraint condition related to a minimum inclusion ratio on a specific object.

17. The computing device of claim 13, wherein the second processor generates an update event representing that one of the AI models is updated,
wherein the first processor
re-performs inference on each training dataset by using only an updated AI model, based on the update event, and
calculates second inference data for each updated model-dataset combination, based on a result of the re-performed inference,
wherein the second processor
compares the second inference data, calculated for each updated model-dataset combination, with the ground truth data included in each training dataset to calculate second performance metrics,
analyzes the second performance metrics calculated for each updated model-dataset combination and the first performance metrics calculated for each non-updated model-dataset combination to select second candidate datasets satisfying the selection condition from among the training datasets; and
combines the second candidate datasets to generate a second evaluation dataset.

18. The computing device of claim 13, wherein the second processor generates an update event representing that one of the training datasets is updated,
wherein the first processor
re-performs inference on only an updated training dataset by using each of the AI models, based on the update event, and
calculates second inference data for each model-updated dataset combination, based on a result of the re-performed inference,
wherein the second processor
compares the second inference data, calculated for each model-updated dataset combination, with the ground truth data included in each training dataset to calculate second performance metrics,
analyzes the second performance metrics calculated for each model-updated dataset combination and the first performance metrics calculated for each non-updated model-dataset combination to select second candidate datasets satisfying the selection condition from among the training datasets, and
combines the second candidate datasets to generate a second evaluation dataset.

19. A system of automatically reconstructing an evaluation dataset, the system comprising:
a storage configured to store artificial intelligence (AI) model performing a same task and training datasets; and
a computing device,
wherein the computing device comprises:
a first processor configured to perform inference on each training dataset by using each AI model to calculate first inference data for each model-dataset combination; and
a second processor,
wherein the second processor
compares the first inference data, generated for each model-dataset combination, with ground truth data included in each training dataset to calculate first performance metrics,
analyzes the first performance metrics,
selects first candidate datasets satisfying a selection condition from among the training datasets, based on an analysis result, and
combines the first candidate datasets to generate a first evaluation dataset.

20. The system of claim 19, wherein the selection condition comprises:
a first selection condition for selecting a dataset of lowest performance metrics in all of the AI models; and
a second selection condition for selecting a dataset of a greatest performance metrics deviation between the AI models.
